(19) United States
(12) Patent Application Publication
(10) Pub. No.: US 2006/0027030 A1
(43) Pub. Date: Feb. 9, 2006

(54) Device and process for determining an acceleration-independent tilt angle

(76) Inventor: Martin Schofl, Tiefenbach (DE)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 11/198,161

(22) Filed: Aug. 8, 2005

(30) Foreign Application Priority Data
Aug. 9, 2004 (DE) 102004038657.9

(51) Int. Cl. G01L 3/00

(52) U.S. Cl. 73/862.08

(57) ABSTRACT

Device and process for determining an acceleration-independent tilt angle of a mobile object, in particular of a single drum roller, wherein the device comprises of a tilt angle sensor with which it is possible to record the tilt angle of the object in a plane, a speed sensor with which it is possible to record the instantaneous speed of the object, a computer by means of which the instantaneous acceleration of the object can be recorded using its instantaneous speed so as to determine by means of the computer, a pitch angle of the recorded tilt angle caused by the instantaneous acceleration of the object and to determine from this an acceleration-independent tilt angle.

The present invention relates to a device and a process for determining a tilt angle of a mobile object, such as for instance, of construction equipment and in particular, of a single drum roller independent of its acceleration.

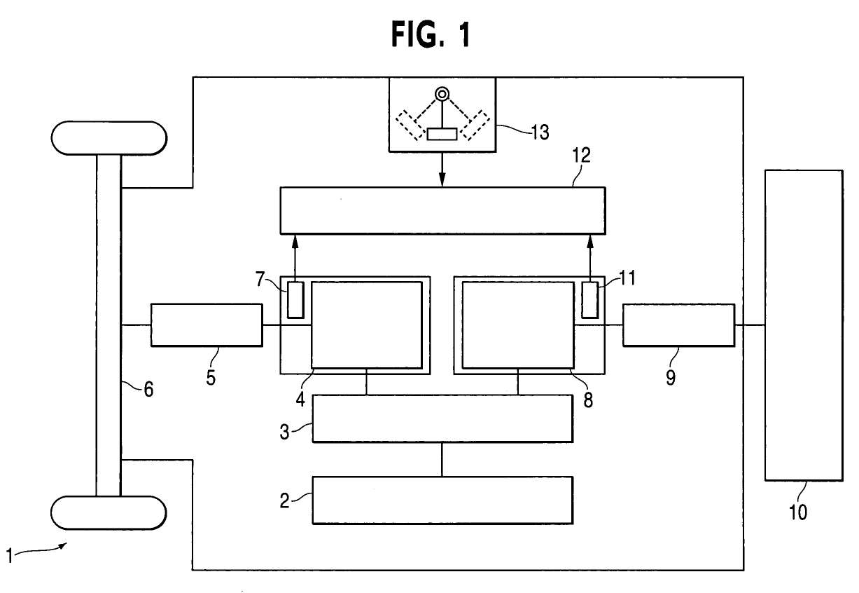

As is generally known, single drum rollers are used for soil compaction in earth-moving operations and in the construction of traffic routes. According to the prior art, a single drum roller having a traction drive is known that is illustrated schematically in FIG. 1. The single drum roller 1 comprises of a diesel motor 2 driving a hydraulic pump 3, such as for instance, a variable displacement pump using two conveying directions. The power of the hydraulic pump 2 is transmitted to two hydraulic motors 4, 8 arranged downstream to the hydraulic pump. The hydraulic motor 4 is coupled to a gear unit 5 that drives a rear axle 6. Similarly, the hydraulic motor 8 is coupled to a gear unit 9 that drives a front axle 10, such as for instance a rolling element (drum) of a single drum roller. In order to enable the safe control of different operating modes, each of the hydraulic actuators is activated and controlled electrically. This also includes controlling the discharge flow of the hydraulic pump and suction volume of the hydraulic motors.

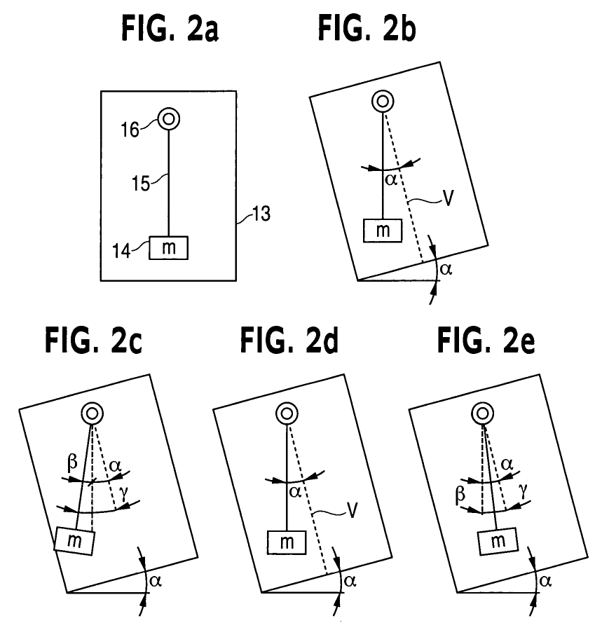

For the purpose of control during the operating modes of ‘power limiting control’ and ‘constant speed control’ of the traction drive of the single drum roller, it is necessary to record the number of revolutions of the drive shaft of a hydraulic motor and/or the speed at which the traction drive is moved. This takes place by means of speed sensors 7, 11 on each of the hydraulic motors 4, 8, wherein the signals of the speed sensors are fed to an electrical control system (not illustrated). For the operating mode of ‘traction control’ it is necessary to determine not only the speed of the drive shaft of each of the hydraulic motors but also the horizontal tilt of the single drum roller. This is achieved by means of a tilt angle sensor 13. The tilt angle recorded by the tilt angle sensor 13 depends on the location and the operating state of the single drum roller. FIG. 2 illustrates schematically the angle recorded by the tilt angle sensor depending on the location and the operating state of the single drum roller. For the purpose of recording the tilt, the tilt angle sensor 13 comprises of a pendulum, for example, that is illustrated in FIG. 2 as a mathematical pendulum. The principle of evaluating the measurement signal and the evaluation electronics are not illustrated here.

FIG. 2a illustrates a tilt angle sensor 13 comprising of a seismic mass 14 that is suspended on a pendulum arm 15 and is located in a bearing 16. If the single drum roller and/or the object is located horizontally and if the object is in a motionless state or if it travels at a constant speed, then the pendulum arm forms an angle of 0° to the plumb line and/or to the object's vertical position.

If the object is located on a slant plane that is tilted horizontally by the angle α, (FIG. 2b), then the object's vertical position V and the pendulum arm are located at an angle α to one another. Such a state comes into existence if the object is either in a motionless state or is traveling at constant speed.

If the object is located on a plane that is tilted horizontally by the angle α and if it is accelerated positively (for instance during the start of the single drum roller on the tilted plane), then in comparison to the situation in FIG. 2b, the tilt angle sensor records the angle γ, (see FIG. 2c). The angle γ is a sum angle of the angle α and the angle β, where β>0 and thus γ is not equal to α. The tilt angle sensor records the angle γ instead of the actual horizontal tilt α.

If the acceleration reaches the value 0 after the start of the object, which is located on the plane that is tilted horizontally by the angle α so that a constant speed is present, then the tilt angle sensor records the correct tilt angle α (see FIG. 2d), where γ is equal to α.

During the negative acceleration of the object that is located on a plane that is tilted horizontally by the angle α, the tilt angle sensor records a tilt angle γ, where γ<α, (see FIG. 2e). During negative acceleration, the seismic mass 14 is moved toward the front due to its inertia, so that instead of the angle α, the tilt angle sensor records an angle γ that is reduced by the pitch angle β.

The said relations also apply to a slant plane that is inclined by −α.

Thus during both a negative acceleration as well as during a positive acceleration, the tilt angle sensor records an angle γ that is not equal to the tilt angle α of a horizontally tilted plane. If an angle signal that is falsified in this manner is relayed for the purpose of controlling the traction drive, the quality of the climbing ability of the object reduces in the operating mode ‘traction control.’

From the prior art sensors are known that can record a tilt angle, which is largely independent of the disturbance variables described above. However, the disadvantage here is that these sensors are either difficult to obtain or are far more expensive than the sensors that are not acceleration-compensated due to their complex manufacturing technology.

The present invention achieves the objective of creating a device for determining a tilt angle of a mobile object that correctly determines the actual tilt independent of the acceleration of the object. In doing so, the said device does not require any additional components and thus proves to be cost-effective.

The device according to the present invention for determining a tilt angle of a mobile object, in particular of construction equipment, comprises of:
a tilt angle sensor with which it is possible to record the tilt angle of the object in a plane,
a speed sensor with which it is possible to record the instantaneous speed of the object,
a computer by means of which the instantaneous acceleration of the object can be determined using its instantaneous speed
   so as to determine by means of the computer a pitch angle of the recorded tilt angle caused by the instantaneous acceleration of the object and to determine from this an acceleration-independent tilt angle.

This is advantageous because using a speed sensor and a tilt angle sensor, which are usually already available, for instance in single drum rollers, it is possible to correct a measurement result that is falsified by a disturbance variable such as the start-up acceleration or the brake deceleration in such a manner that the actual horizontal tilt of the object can be determined.

In a first preferred embodiment of the device according to the present invention, a tilt angle sensor is used that is not an acceleration-compensated tilt angle sensor. This consequently enables the application of a simple, cost-effective tilt angle sensor that is also easy to obtain.

In a second preferred embodiment of the device according to the present invention, the tilt angle sensor records the tilt angle by means of a seismic mass. A sensor of this type can be manufactured using microsystems technology in such a manner that it is resistant to shock, vibrations and temperature fluctuations.

In a third preferred embodiment of the device according to the present invention, the computer can determine a variable that is proportionate to the acceleration using the seismic mass of the tilt angle sensor and the instantaneous acceleration. This is advantageous because the accelerating force need not be determined directly. Instead it can be determined using two known variables—the seismic mass and the instantaneous acceleration. Using the accelerating force it is possible to create a correction function with which the pitch angle caused by the instantaneous acceleration and/or the actual tilt of the slant plane can be indicated directly.

In a fourth preferred embodiment of the device according to the present invention, the tilt angle sensor is an electric tilt angle sensor. This is advantageous because the tilt angle exists on the sensor as an electrical variable, for instance as an output voltage, and can be used directly for the computer and for the electrical control of the traction drive.

In a fifth preferred embodiment of the device according to the present invention, the tilt angle sensor is fastened to the object. This is advantageous because it increases the reliability of the recorded tilt angle. Furthermore, it can prevent transmission errors from an external device to the mobile object.

In a sixth preferred embodiment of the device according to the present invention, the speed sensor records the instantaneous speed of a drive shaft of a hydraulic motor of the mobile object. This is advantageous because the gear unit arranged downstream to the hydraulic motor is constantly driven using the target speed, for instance, by means of an electronic control system.

The process according to the present invention for determining a tilt angle of a mobile object, in particular of construction equipment, comprises of the following steps:
recording a tilt angle in a plane by means of a tilt angle sensor,
recording an instantaneous speed of the object by means of a speed sensor,
recording an instantaneous acceleration of the object by means of a computer using its instantaneous speed
   so as to determine by means of the computer a pitch angle of the recorded tilt angle caused by the instantaneous acceleration of the object and to determine from this an acceleration-independent tilt angle.

This is advantageous because using a speed sensor and a tilt angle sensor, which are usually already present, for instance in single drum rollers, it is possible to correct a measurement result that is falsified due to a disturbance variable such as the start-up acceleration or the brake deceleration in such a manner that the actual horizontal tilt of the object is determined.

In a seventh preferred embodiment of the process according to the present invention, the computer determines an accelerating force using the seismic mass of the tilt angle sensor and the instantaneous acceleration. This is advantageous because the accelerating force need not be determined directly. Instead it can be determined using two known variables. Using the accelerating force it is possible to create a correction function using which the pitch angle caused by the instantaneous acceleration can be indicated directly.

According to an additional feature of the present invention, the application of the device and the process is intended for a traction control of the mobile object. This is advantageous because it enables the improvement of the traction control and the gradeability of the mobile object.

Preferred embodiments of the present invention are set forth in the following description with reference to the drawing of which:

FIG. 1 illustrates schematically the traction drive of a single drum roller according to the prior art;

FIGS. 2a to 2e illustrate schematically a tilt angle sensor depending on the location and the operating state of the single drum roller;

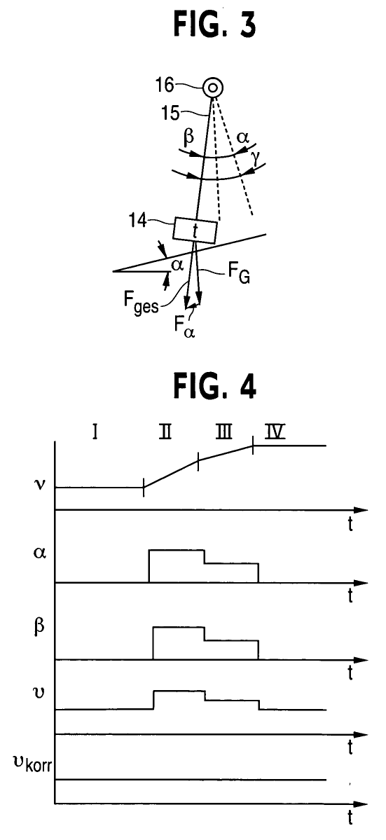

FIG. 3 illustrates schematically the relations of force to the seismic mass of the tilt angle sensor;

FIG. 4 illustrates a chart with the variables of speed, acceleration, pitch angle of the recorded tilt angle and sensor output variable, depending in each case on the time.

FIG. 3 illustrates schematically a pendulum comprising of a seismic mass 14, a pendulum arm 15 and a bearing 16. As is evident in FIG. 3, the bearing can be a pivot bearing having a friction, which is too negligible for the tilt measurement. However, instead of the pivot bearing with a pendulum arm fastened to it and a mass 14 attached to the latter, it is also possible to use a leaf spring that is clamped on one side and has a mass 14 at its end. In case of a mathematical pendulum, it is assumed that the pendulum arm is massless and that the entire mass 14 forms one point. However, there is no prerequisite to use a mathematical pendulum for the device according to the present invention. Even the use of a physical pendulum is feasible in which a rotating body is suspended in a pivot point located in the rotating body. The use of arbitrary intermediate forms that can be ranked between the mathematical pendulum and the physical pendulum is also feasible in the device according to the present invention for determining the tilt angle. However, every design of the tilt angle sensor must necessarily display a proportion between the actual tilt and the recorded tilt angle.

In an electrical tilt angle sensor, the recorded tilt angle is converted into an electrical output signal using, for instance, a differential capacitor. There the seismic mass suspended on a spring forms a mobile central electrode in addition to the two adjoining fixed electrodes. A tilt of the sensor element causes a deflection of the seismic mass from its neutral position and thus an imbalance of the differential capacitor. Such a variation in the capacity can be converted using suitable evaluation electronics into a variable to be processed further, such as an electrical voltage, a frequency or a pulse width. The tilt angle sensor can also work according to the conductometric principle, in which depending on the tilt of the sensor, the outer electrodes are wetted variably by an electrolytic liquid. This results in a tilt-dependent electrical resistance. Another alternative is to displace a rheostat depending on the tilt of the pendulum.

For the purpose of determining the pitch angle β illustrated in FIG. 3, which comes into existence due to the effect of a disturbance variable such as an accelerating force, it is possible to determine firstly the direction and secondly the length of an accelerating force vector Fₐ. Moreover, if the direction and the length of the weight force vector F_{G} are already known, then the addition of the vectors results in the resultant force F_{ges} that acts on the seismic mass 14 and deflects the pendulum accordingly. The pitch angle β can be assigned to this resultant force, for instance by calculation or by experiment. In the sketch illustrated in FIG. 3, it is assumed for the purpose of simplicity, that a direct proportion formed using factor 1 exists between the vector of the resultant force F_{ges} and the angle β. Actually however, there can be a proportionality that deviates from factor 1. This does not change the fact that a pitch angle can be assigned to the resultant force.

The accelerating force Fₐ is calculated from the product of the amount of the seismic mass 14 with the instantaneous acceleration a(t) according to the equation
Fₐ(t)=m·a(t). (1)

The acceleration ·a(t) results from the differences in the instantaneous speed v(t) depending on the time according to the equation
a(t)=dv(t)/dt. (2)

In the device according to the present invention, the computer 12 performs this calculation.

The speed of the single drum roller is known due to a measurement signal of the speed sensor 7, 11 on the drive shaft of a hydraulic motor. If the speed is not a control or regulating variable, then it represents at least a display variable that can be used similarly for calculation according to the equation (1) or (2).

If the accelerating force Fₐ and the associated pitch angle β are known, it is possible to determine from the recorded tilt angle γ the actual tilt angle α of the horizontally tilted plane, (see FIG. 3).

FIG. 4 illustrates schematically the interrelationship between the speed ν, acceleration α, pitch angle β and an output variable U of the tilt angle sensor depending on the time. At constant speed, phase I, the acceleration a=0. The associated pitch angle equals β=0 (see FIGS. 2a, 2b). The output variable of the tilt angle sensor has a positive value if the object travels on a plane that is tilted by the angle α. In case of a constantly increasing instantaneous speed, phase II, it is possible to calculate a constant positive instantaneous acceleration from the differentiation depending on the time so that the seismic mass is constantly deflected additionally by the pitch angle β (see FIG. 2c). The output variable U has a higher value than in phase I. In case of an additionally increasing instantaneous speed, however with decreasing pitch, phase III, a continued constant positive instantaneous acceleration can be calculated and the seismic mass 14 is deflected by a smaller pitch angle β. The output variable U has a lower value than in phase II. If the instantaneous speed does not increase any more, phase IV, then the instantaneous acceleration a=0 and the pitch angle β=0, (see FIG. 2d).

An electrical tilt angle sensor indicates an output value associated with the recorded tilt angle γ, for instance, an output voltage U. If the pitch angle β is known, then it is possible to correct the output value of the tilt angle sensor accordingly into an output variable Uₖₒᵣᵣ (see FIG. 4).

Using the device according to the present invention, it is not urgently required to determine the accelerating force Fₐ in order to indicate the pitch angle β and thus determine an acceleration-independent tilt angle. It is sufficient to experimentally establish a correlation between the acceleration and the recorded tilt angle γ and/or the output variable U in case of a known tilt angle α of a horizontally tilted plane. The difference in the recorded tilt angle γ and the actual tilt angle α of a horizontally tilted plane results in the pitch angle β associated with the instantaneous acceleration a. This proportion of the instantaneous acceleration a and the pitch angle β, which must be interpreted as the angle of correction, can be applied to the output variable U in the form of a correction function fₖₒᵣᵣ (a(t)). Without the application of the correction function fₖₒᵣᵣ (a(t)), the instantaneous output variable U(t) is a variable that is dependent on the actually recorded tilt angle γ and the instantaneous acceleration a(t) of the object:
U(t)=f(γ, a(t)) (3)

If the correction function is applied, then the dependence of the instantaneous output variable U(t) reduces to the actual tilt angle α:
U(t)ₖₒᵣᵣ=f(γ, a(t)) [symbol] fₖₒᵣᵣ(a(t))=f(a). (4)

Thus the device and the process according to the present invention determine a tilt signal that indicates the actual tilt of the single drum roller independent of the acceleration of the single drum roller.

1. Device for determining a tilt angle of a mobile object, in particular of construction equipment, comprising:
a tilt angle sensor with which it is possible to record the tilt angle of the object in a plane,
a speed sensor with which it is possible to record the instantaneous speed of the object,
a computer by means of which the instantaneous acceleration of the object can be determined using its instantaneous speed
so as to determine by means of the computer a pitch angle of the recorded tilt angle caused by the instantaneous acceleration of the object and to determine from this an acceleration-independent tilt angle.

2. Device pursuant to claim 1, wherein the tilt angle sensor used is not an acceleration-compensated tilt angle sensor.

3. Device pursuant to claim 1, wherein the tilt angle sensor can record the tilt angle by means of a seismic mass.

4. Device pursuant to claim 3, wherein it is possible to determine a value proportionate to the acceleration by means of the computer and using the seismic mass of the tilt angle sensor and the instantaneous acceleration.

5. Device pursuant to claim 1, wherein the tilt angle sensor is an electrical tilt angle sensor.

6. Device pursuant to claim 1, wherein the tilt angle sensor is fastened to the object.

7. Device pursuant to claim 1, wherein the speed sensor records the instantaneous speed on a drive shaft of a hydraulic motor of the mobile object.

8. Process for determining a tilt angle of a mobile object, in particular of a construction equipment, comprising of the following steps:
recording a tilt angle in a plane by means of a tilt angle sensor,
recording an instantaneous speed of the object by means of a speed sensor,
recording an instantaneous acceleration of the object by means of a computer using its instantaneous speed
so as to determine by means of the computer, a pitch angle of the recorded tilt angle caused by the instantaneous acceleration of the object and to determine from this an acceleration-independent tilt angle.

9. Process pursuant to claim 8, wherein a value that is proportionate to the acceleration is determined by means of the computer and using the seismic mass of the tilt angle sensor and the instantaneous acceleration.

10. Process pursuant to claim 9, wherein the process is utilized for traction control of the mobile object.

11. (canceled)
